(19) United States
(12) Patent Application Publication
(10) Pub. No.: US 2004/0182218 A1
(43) Pub. Date: Sep. 23, 2004

(54) Saw blade

(76) Inventor: Walley Chao, Taichung (TW)

Correspondence Address: BACON & THOMAS, PLLC, 625 SLATERS LANE, FOURTH FLOOR, ALEXANDRIA, VA, 22314

(21) Appl. No.: 10/393,260

(22) Filed: Mar. 21, 2003

(51) Int. Cl. B27B 33/02; B23D 57/00

(52) U.S. Cl. 83/848

(57) ABSTRACT

A saw blade includes a base body and a plurality of groups of saw teeth. Each group of saw teeth is provided with a first section and a second section, wherein the first and second sections are adjacently positioned and respectively include a plurality of pre-cutting saw teeth, each of which has a first clearance angle, and re-cutting saw teeth, each of which has a second clearance angle. The pitch between each two saw teeth is the same with the others, but the first clearance angle of the pre-cutting saw teeth and the second clearance angle of the re-cutting saw teeth are different from each other.

### BACKGROUND OF THE INVENTION

1. Field of the Invention

The present invention relates generally to saw blades, and more particularly to an improved saw blade.

2. Description of the Related Art

A conventional saw blade 10 shown in FIG. 1 includes a base body 11 and a plurality of saw teeth 12 formed at a side of the base body 11. While in use, the saw blade 10 is reciprocated to cut a workpiece and then a plurality of chippings will be produced during the cutting process and driven to eject out of tooth gaps between the saw teeth 12, thereby a cut will be formed on the workpiece and go further inside the workpiece as the cutting process continues.

Although the saw blade 10 is capable of cutting, each of the saw teeth 12 of the saw blade 10 is provided with a single shape only, i.e. all the saw teeth of regular saw blades are shaped similiarly and differ merely in that the saw teeth are inclined towards different directions. Another conventional saw blade provided with no front clearance angles on saw teeth thereof is slow in cutting, thereby causing the saw blade to work inefficiently. On the contrary, another conventional saw blade provided with aforesaid front clearance angles on saw teeth thereof is quick in cutting but is less durable than the aforesaid saw blade without the front clearance angles, thereby causing the saw blade to be damaged or worn-out. Nevertheless, all of the aforementioned conventional saw blades fail to cut quickly and to be durable.

### SUMMARY OF THE INVENTION

The primary objective of the present invention is to provide an improved saw blade, which is capable of quick cutting and durability.

The foregoing objective of the present invention is attained by the improved saw blade, which is formed of a base body and a plurality of groups of saw teeth. Each group of saw teeth is provided with a first section and a second section, wherein the first and second sections are alternately successively positioned and respectively include a plurality of pre-cutting saw teeth each having a first clearance angle, and re-cutting saw teeth each having a second clearance angle. The pitch between each two saw teeth is the same with the others, but the first and second clearance angles of each pre-cutting and re-cutting saw teeth are different from each other.

### BRIEF DESCRIPTION OF THE DRAWINGS

FIG. 1 is a partial side view of a prior art;

FIG. 2 is a partial side view of a preferred embodiment of the present invention;

FIG. 3 is a partial side view of the preferred embodiment of the present invention, showing a group of saw teeth; and

FIG. 4 is a partial schematic view of FIG. 3 in an enlarged scale.

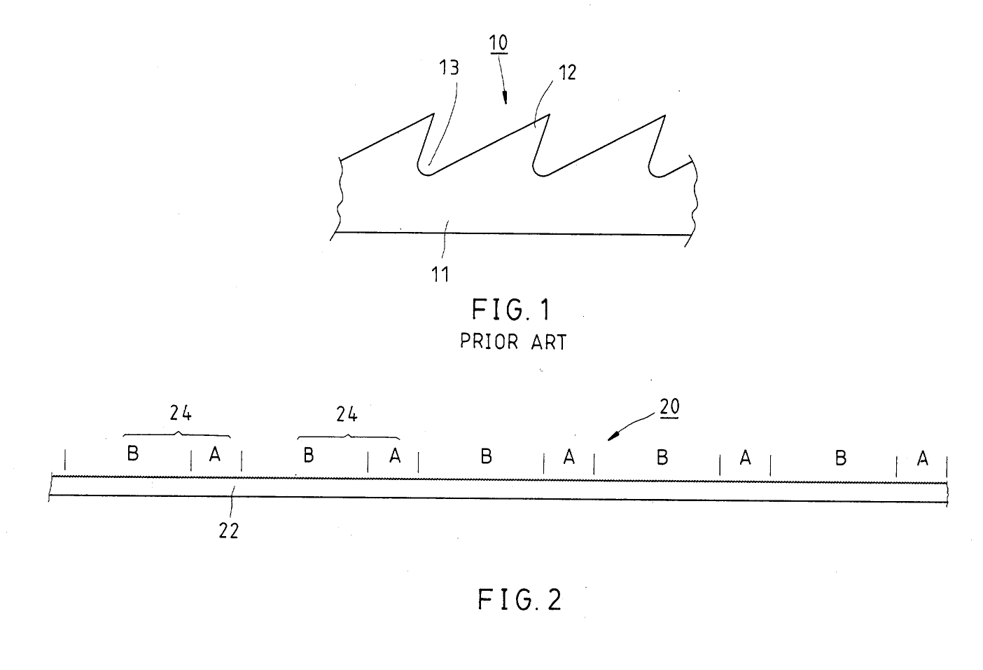

### DETAILED DESCRIPTION OF THE INVENTION

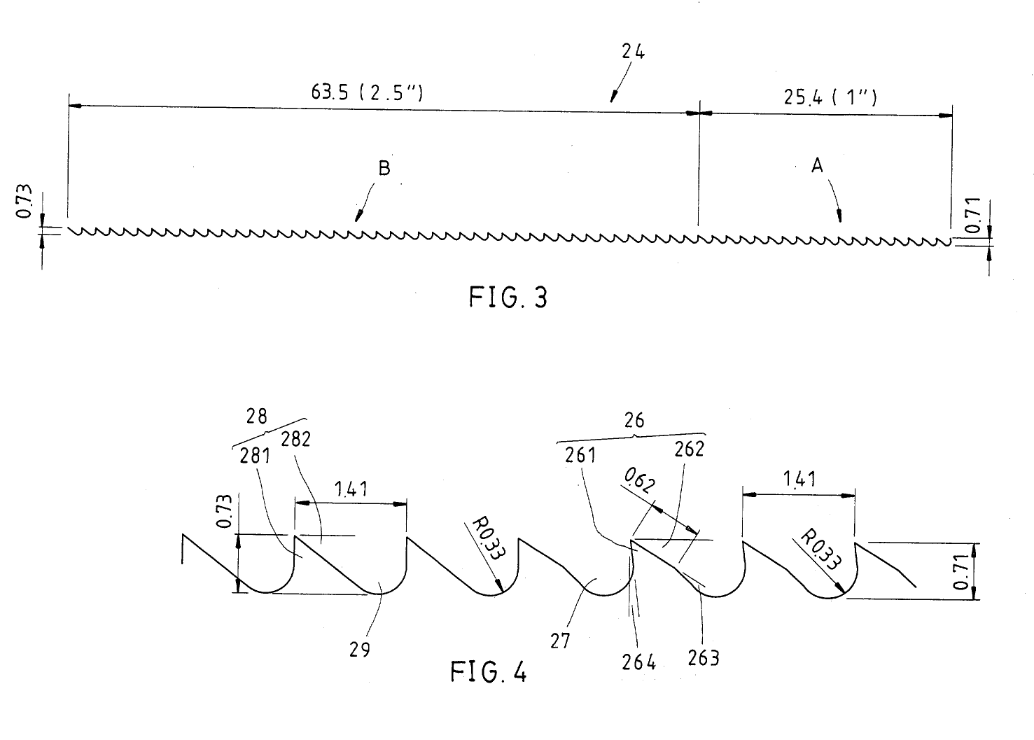

Referring to FIGS. 2-4, an improved saw blade 20 of the present invention is composed of a base body 22 and a plurality of groups of saw teeth 24 positioned along a side of the base body 22.

Each group of the saw teeth 24 is formed of a first section A and a second section B, which are successively positioned section by section and respectively include a plurality of pre-cutting saw teeth 26 and re-cutting teeth 28. The proportion of the length of the first section A to the second section B is 1:2.5 in this embodiment. The proportion of the pitch of each two pre-cutting saw teeth 26 therebetween to each two re-cutting saw teeth therebetween is 1:1 in this embodiment. The proportion of the length of each section A of the pre-cutting saw teeth 26 to the height of which is 25.4:0.71 in this embodiment. The proportion of the length of each section B of the re-cutting saw teeth 28 to the height of which is 63.5:0.73 in this embodiment. Each pre-cutting tooth 26 is provided with a first wedge angle 261, a first clearance angle 262, a front relief angle 263, and a rake angle 264. A pre-cutting tooth gap 27 is formed between each two pre-cutting saw teeth 26. The proportion of the radius of the pre-cutting tooth gap 27 to the pitch between each two pre-cutting saw teeth 26 to the height of each pre-cutting saw tooth 26 is 0.37:1.41:0.71. Each re-cutting saw tooth 28 is provided with a second wedge angle 281 and a second clearance angle 282. A re-cutting tooth gap 29 is formed between each two re-cutting saw teeth 28. The proportion of the radius of the re-cutting tooth gap 29 to the pitch between each two re-cutting saw teeth 28 to the height of each re-cutting saw tooth 28 is 0.33:1.41:0.73 in this embodiment.

The saw blade 20 of the present invention at work is described hereunder. Since a workpiece may have a high friction factor, the saw blade may inefficiently cut the workpiece. While the saw blade 20 is cutting the workpiece, a cut will be generated by the cutting of the pre-cutting saw teeth 26 and then facilitates the further cutting of re-cutting saw teeth 28. After the further cutting of re-cutting saw teeth 28 and the pre-cutting saw teeth 26 alternately on the cut of the workpiece, the cut will go further into a predetermined depth of the workpiece.

In a conclusion of our constant research, a saw blade composed of irregular saw teeth positioned alternately and successively is more effective in cutting and more durable than another saw blade composed of uniform saw teeth. Accordingly, the saw blade 20 of present invention having the aforementioned structure of the pre-cutting saw teeth and the pre-cutting tooth gaps is highly effective in ejecting chippings produced while cutting the workpiece and is quick in cutting. Moreover, the saw blade 20 of present invention having the aforementioned structure of the re-cutting saw teeth and the re-cutting tooth gaps is preferably durable, and not only reduce wear and tear of saw teeth but also keep cutting quickly while the pre-cutting and the re-cutting saw teeth work alternately. In addition, the saw blade of the present invention can be alternatively in the shape of band saw or arched saw or bore saw.

Furthermore, the first section A and the second section B are positioned alternately and successively in the groups of the saw teeth 24 of the saw blade 20 of the present invention. Because the first and second clearance angles are different and positioned alternately, the saw blade 20 can cut the workpiece quickly with little effort without cutting the workpiece too quickly or damaging it, thereby causing the balance of the best working efficiency and the best durability of the present invention.

What is claimed is:

1. A saw blade comprising:
a base body; and
a plurality of groups of saw teeth positioned at a side of said base body, each group of said saw teeth including a first section and a second section, said first and second sections being successively positioned and respectively having a plurality of pre-cutting saw teeth and re-cutting saw teeth, each of said pre-cutting saw teeth having a first clearance angle, each of said re-cutting saw teeth having a second clearance angle, said first clearance angle being different from said second clearance angle.

2. The saw blade as defined in claim 1, wherein each of said pre-cutting saw teeth is lower than each of said re-cutting saw teeth in height.

3. The saw blade as defined in claim 2, wherein the proportion of the height of each said pre-cutting saw tooth to the height of each said re-cutting saw tooth is 0.71:0.73.

4. The saw blade as defined in claim 1, wherein said first clearance angle is smaller than said second clearance angle.

5. The saw blade as defined in claim 1, wherein the length of said first section is shorter than that of said second section.

6. The saw blade as defined in claim 5, wherein the proportion of the length of said first section to said second section is 1:2.5.

7. The saw blade as defined in claim 1, wherein a pre-cutting tooth gap is defined between each two said pre-cutting teeth and the pre-cutting tooth gap has a smaller radius than the height of each said pre-cutting saw tooth, and the height of said each said pre-cutting saw tooth is smaller than the pitch between each two said pre-cutting saw teeth.

8. The saw blade as defined in claim 7, wherein the proportion of the radius of each said pre-cutting tooth gap to the pitch between each two said pre-cutting saw teeth to the height of each said pre-cutting saw tooth is 0.37:1.41:0.71.

9. The saw blade as defined in claim 1, wherein a re-cutting tooth gap is defined between each said re-cutting tooth and the re-cutting tooth gap has a smaller radius than the height of each said re-cutting saw tooth, and the height of said each said re-cutting saw tooth is smaller than the pitch between each two said re-cutting saw teeth.

10. The saw blade as defined in claim 9, wherein the proportion of the radius of each said re-cutting tooth gap to the pitch between each said two re-cutting saw teeth to the height of each said re-cutting saw tooth is 0.33:1.41:0.73.
